(19) United States
(12) Patent Application Publication
(10) Pub. No.: US 2009/0076885 A1
(43) Pub. Date: Mar. 19, 2009

(54) Multiple Data Transfers to Generate User Dependent Lifestyle Choice Recommendation

(76) Inventors: Gene S. Fein, Lenox, MA (US); Edward Merritt, Lenox, MA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/857,864

(22) Filed: Sep. 19, 2007

(51) Int. Cl. G06Q 30/00; G06F 17/30; G06F 17/40

(52) U.S. Cl. 705/10

(57) ABSTRACT

Disclosed are media based lifestyle choice recommendation systems, methods, and apparatus using multiple data transfers from numerous accessible database resources to automatically generate lifestyle choice type recommendations. These recommendations are based upon media collection and other associated information related to the user found in databases, screen scrapes or local searches of the user's computer. This information is made available by the user or formulated by the system using gathered and sorted data. One embodiment obtains data by ID3 tag conversion, fuzzy string searching, built in support to third party systems and media players with work-a-rounds or API support. Other embodiments utilize automated screen scrapes employing additional techniques, including perl scripts and software for the visually impaired. Another embodiment utilizes prior purchase information or an IP address “sniffer.” Recommendations may be presented spontaneously or upon user request, as pure data options or with a paid for sponsor integration ad model.

### BACKGROUND OF THE INVENTION

It is known that online recommendation systems can provide users with useful information regarding user interests ranging from topics such as:

real estate, relationships, media, insurance, restaurants and travel. Websites, such as iTunes.com, Match.com, Amazon.com, Travelocity.com, Progressive.com and many others, offer recommendations and “ideas” for users to refer to for possible purchases. It is also known that data for recommendation engines functioning online can utilize a variety of user data that may be obtained and falls into three basic categories. The first category is user supplied information; the second is information derived from the user's actions, which is also known as implied data; and, the third is known as applied or demographic data that can be employed to “target” a user's future behavior based upon the actions of a selection or group of users who contain similar or exact data points to the user. Additionally, certain sets of data or data points are synthesized through coding and decoding systems, computer programs, application programming interface (API) programming and database searches to identify relevant data to be gathered, sorted, and ultimately reacted upon as well as used for recommendation data analysis and results. One such system coding and decoding music online is U.S. Pat. No. 7,085,845 (issued on Aug. 1, 2006) which discloses a method, apparatuses and computer program product for identifying a playing media recording file and tracking associated user preferences.

### SUMMARY OF THE INVENTION

Currently, websites such as the ones cited herein usually function with recommendation engines that utilize at least one form of synthesizing data or data points, as generally described above, towards processing available data as well as filtering, sorting, and matching data results in a database via programmed rules and then presenting recommendations generating results in specific fields of interest such as those fields stated above.

Unfortunately, the existing conventional uses have certain limitations. The primary limitations are two fold. First, the methods by which recommendations are obtained are limited and rarely synthesized and/or prioritized among each other to generate recommendation suggestions to users. That is, most recommendation engines use a single method to generate recommendation results and occasionally a dual method to actualize data and generate a list of possible recommendations. Second, most recommendation engines present recommendations in a specialized field, such as music, and only use music-related data to generate music or other specialized recommendations to users.

The summary that follows details some of the embodiments included in the present invention. The information is proffered to provide a fundamental level of comprehension of aspects of the present invention.

An embodiment of the present invention includes multiple processor systems, method, and apparatus that employ multiple data transfers to generate a user dependent lifestyle choice recommendation. One embodiment includes a data module, a processing unit, and a delivery unit. The data module may be configured to receive user-entered and/or third party-entered/generated data and maintain an aggregate of accumulated data entry. The accumulated data entry (or accumulated data) includes user-entered data and third party-entered data (and/or third party generated data). The processing unit may be coupled to the data module and includes a database of entered/generated data and accumulated data. The processing unit may be configured to synthesize the accumulated data to match with a media based lifestyle choice recommendation and to organize the media based lifestyle choice recommendation(s).

The delivery unit may be coupled to the processing unit and configured to deliver the media based lifestyle choice recommendation to the user based on the match.

A lifestyle choice may include a user's present and future standard of living based upon day-to-day goods or services usage, needs, goals, desires, options, preferences, necessities, activities, economic standing, and mental or physical condition.

The data entry module and delivery unit may each be an electronic device. An electronic device may be any of a computer, handheld device, mobile device, or display monitor. The accumulated data may include information about the user, a third party associated with the user, or group of users. The information about the third party may be ranked for relevancy based upon the relationship of the user to the third party or group of users. The data module and the delivery unit may be contained within an entry/delivery unit.

The systems, method, and apparatus may also be configured to allow the user to either accept, reject or request a delivery of another media based lifestyle choice recommendation (recommendation).

The systems, method, and apparatus may allow for the delivery of the recommendation via electronic means. Delivery may occur online, in any media form online or offline, directly, or via a targeted demographic marketing campaign, or the like.

The systems, method, and apparatus may also include a tracking unit, which may be coupled to a delivery unit and configured to track a user response to a recommendation. Tracking the user response may include utilizing data, both used and unused in matching the accumulated data with a media based lifestyle choice recommendation. The tracking unit and data entry module may be configured to revise the accumulated data associated with the user, third party, or group of users. Revising the accumulated data may include applying user response and evolving behaviors, both implicit and explicit, for a future recommendation. The systems, method, and apparatus may also allow the user to accept, reject, or request delivery of another media based lifestyle choice recommendation.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a process flow diagram of an example embodiment of media based lifestyle choice recommendation systems and methods in accordance with the present invention.

FIG. 1B is a process flow diagram illustrating providing greater detail of the media based lifestyle choice recommendation systems and methods of FIG. 1A.

FIG. 1C is a block diagram of exemplary data that may be entered by a user or third party and accumulated data about the user or third party that may be used to implement the present invention.

FIG. 2A is a block diagram of the media based lifestyle choice recommendation apparatus in accordance with the present invention.

FIG. 2B is a block diagram providing greater detail of the media based lifestyle choice recommendation apparatus of the present invention as depicted in FIG. 2A.

FIG. 2C is a block diagram of another embodiment of a media based lifestyle choice recommendation apparatus using an entry/delivery unit in accordance with the present invention.

FIG. 3A is an exemplary screenshot of a media based lifestyle choice recommendation that may be generated and delivered by the present invention.

FIG. 3B illustrates a computer network or similar digital processing environment in which the present invention may be implemented.

FIG. 3C is a diagram of the internal structure of a computer node in the computer network of FIG. 3B.

### DETAILED DESCRIPTION OF THE INVENTION

A description of example embodiments of the invention follows.

There is a need for a recommendation engine that may receive data from a variety of sources, synthesize that data, run the data through a variety of forms of focused synthesizing of data or data points, prioritize the recommendations, and deliver recommendations to users via multimedia answer formats, where the user's entire lifestyle and planning is considered and available for recommendations. The present invention discloses systems, methods and apparatuses (generally, “system”) that predict and recommend lifestyle choices across a broad spectrum of subjects, needs, goals, choices, necessities and luxuries based upon a wide range of information available using data synthesis and recommendation engines to use both general and/or user specific data from the user, from the user's demographic information, or from an extended network of personal and business relationships, to create a refined predictor of the needs of the user. An embodiment of the present invention spontaneously presents the user with recommendations or may present recommendations only when prompted. In addition to presenting the recommendations online, another embodiment of the present invention presents the recommendation(s) to the user in any media form online or offline, directly, or via a targeted demographic marketing campaign, or the like.

The system utilizes available data from a variety of media sources that may include demographic information provided by the users; web surfing habits (via cookies and crawlers); cached data stored, including all emails, documents, software programs and media on the computer(s) of the user; credit reports; public records; and, the use of information of other people in the user's family or circle of friends (associated third party information) who have consented to make such information available to the system. Media sources include, but are not limited to, the following examples: recording media from a storage device (e.g., audio and video); published media, which is any information available to the public (e.g., broadcast or news); and media that is delivered or requested using electronic means (e.g., multimedia, hypermedia and digital media). The relationship of the third party to the user may be analyzed to determine a specific level of relevance. For example, friends or peers may be associated with the user's recommendation pool for leisure activities via a collaborative filtering style recommendation system, while the user's family members information may trigger other recommendations, such as Angels v. Red Sox baseball tickets for a twelve-year-old son living in California who subscribes to MLB.com and whose favorite team is the Boston Red Sox. The user can receive alerts (defined by the user or third party) for upcoming birthdays of third party contacts along with recommendations for presents or needs that the contacts may have. Third party contacts are also able to recommend presents or other needs for themselves or for the user. In addition to making recommendations on logical day-to-day consumables, an embodiment of the present invention creates tangible lifestyle choice recommendations that delve deeper into a user's lie and future needs. Additionally, the user may send data that the user views as important to the system's “priority analysis service” for immediate response by the system, or for data to be evaluated over time by the system, or both.

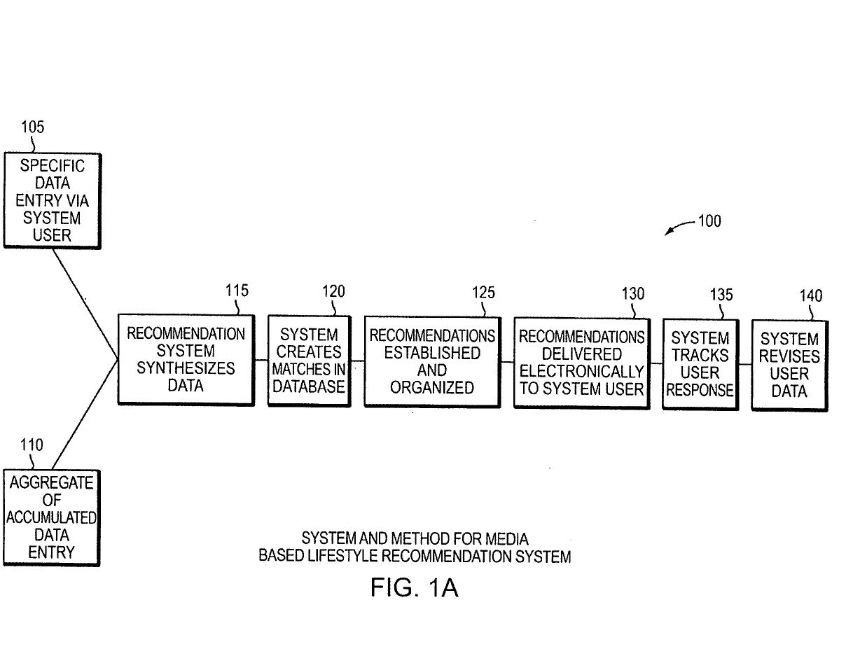

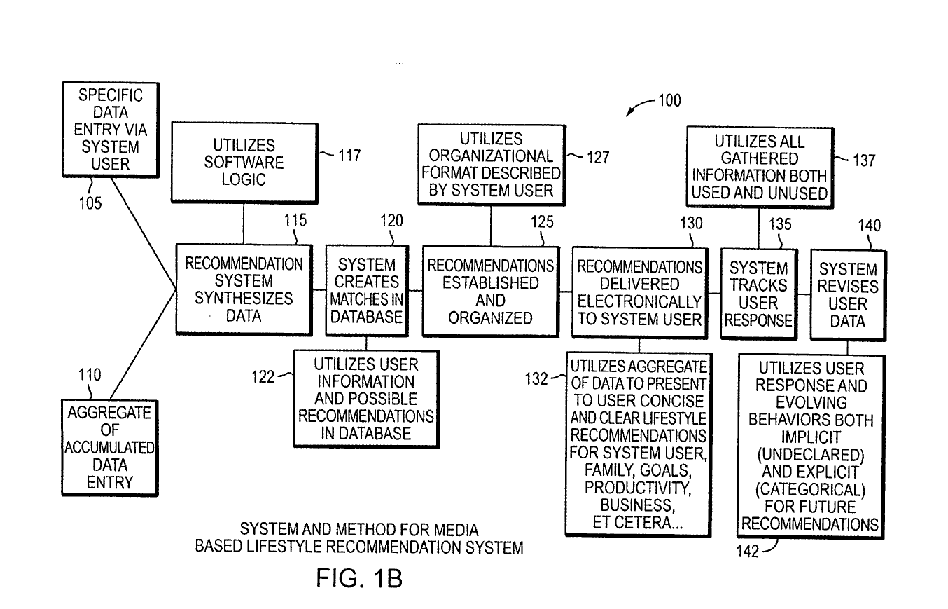

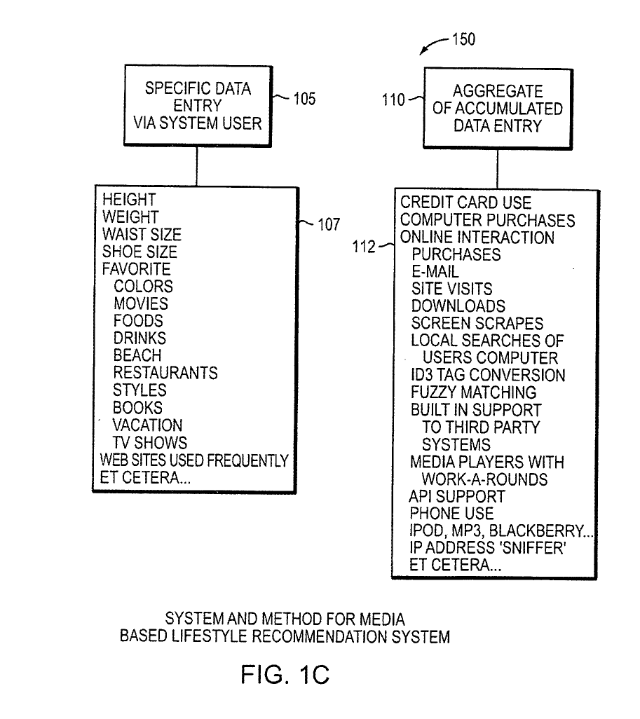

FIG. 1A is a process flow diagram of an example embodiment of media based lifestyle choice recommendation systems and methods (recommendation system) 100 in accordance with the present invention. The system 100 uses specific data input (step 105) by the system user or third party and an aggregate of accumulated data entry (step 110). The aggregate of accumulated data 110 is data from various data sources (e.g., user-entered or third-party-entered/generated) collected over time. Then the recommendation system 100 synthesizes (step 115) the specific data entered by the user (step 105) and the aggregate of accumulated data (step 110) and creates matches in a database (step 120). This may be accomplished using keyword searches, suitable indexing of database data (entries), and other common or known technologies. The media based lifestyle choice recommendations (recommendation) established by the database match is organized (step 125) and delivered electronically (step 130) to the system user. The system tracks (step 135) the user's response to the recommendation and revises (step 140) the user's data accordingly.

FIG. 1B further elaborates on the process flow of the media based lifestyle choice recommendation systems and methods (recommendation system) 100. FIG. 1B illustrates exemplary factors and information that provide further detail of the present invention. The recommendation system parts 105, 110, 115, 120, 125, 130, 135 and 140, as depicted in FIG. 1B, function in the same manner as discussed above in FIG. 1A. In order for the recommendation system 100 to synthesize the data (step 115), the system uses software logic (step 117). Software logic employs an algorithm to process input received (e.g., either user-entered or third party-entered/generated) to output a decision (e.g., recommendation) based upon pre-determined and/or defined axioms and rules and store the decision. While the rules are fixed, the axioms may be changed, which allows for modifications to be made to the present invention. The decision is based on a myriad of techniques, such as user or third party trends, statistics, probability, or the like. The present invention is accomplished using such techniques as keyword searches, suitable indexing of database data (entries), and other common or known technologies.

The system 100 employs user information and possible recommendations in the database (step 122) to create matches in the database (step 120). When the recommendations are established and organized (step 125), the recommendation system 100 uses an organizational format described by the system user (step 127). For example, the recommendations may be organized in ascending, descending, or random order of any user or predefined criteria, such as price, dates, distance from the user, etc. When the recommendation is delivered electronically (step 130) to the system user, the system may use an aggregate of data to present a concise and clear lifestyle choice recommendation (step 132) for the user based upon family, goals, productivity, business, etc. When the system tracks (step 135) the user's response, it may do so based upon all gathered information (step 137), both used and unused to synthesize or match data by the system. To revise the user data (step 140), the recommendation system 100 employs user response and behaviors, both implicit (undeclared) and explicit (categorical), for future recommendations (step 142). The revised data is stored in the database for use by steps 115, 120, and 122.

FIG. 1C is a block diagram 150 of exemplary data that may be user-entered or third party-entered/generated and exemplary data forms of accumulated data entry about the user or third party that may be used to implement the present invention. The specific data that may be entered by the system user (step 105 of FIGS. 1A and 1B) may include such information (107) as height, weight, shoe size, or user or third party favorite things (e.g., colors, movies, foods, or frequently used websites). Additionally, the aggregate of accumulated data maintained by the recommendation system (step 110 of FIGS. 1A and 1B) may include such information (112) as credit card use; computer/online purchases; online interactions, such as sent/received emails, computer network site visits, downloads, screen scrapes and local searches of the user's computer; ID3 tag conversion; API support; built in support to third party systems; media and other player/device use; phone use; etc. Hence, the present invention uses a myriad of techniques to compile electronic data communicated during data transfer between programs that display information in a format appropriate for processing by an electronic device (e.g., computer) or a person. For example, screen scraping is a program configured to remove data displayed by another program in a human-readable format.

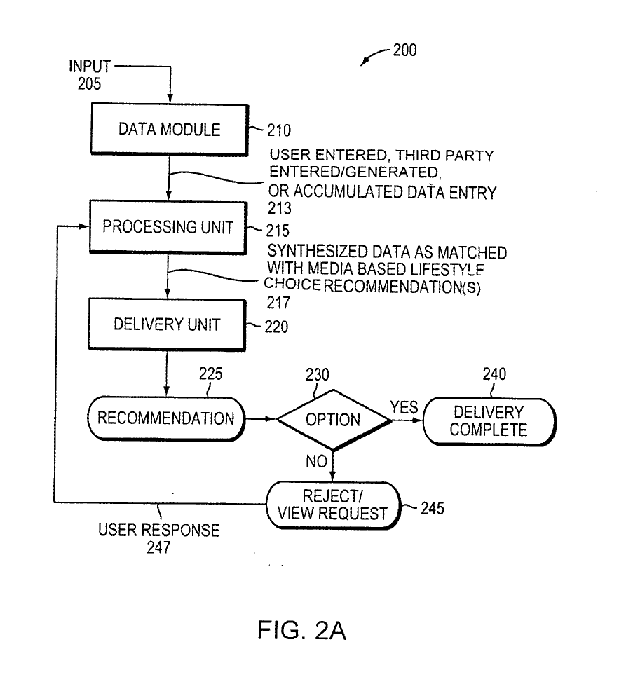

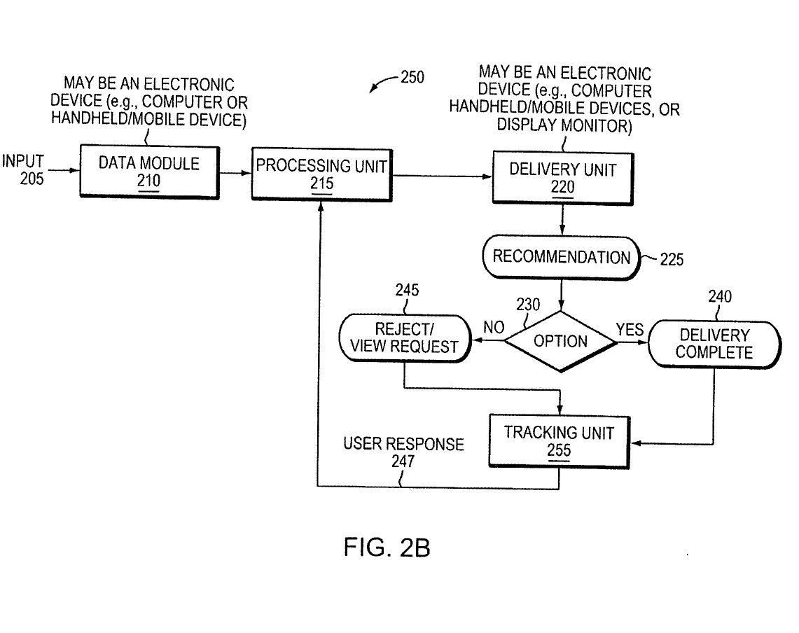

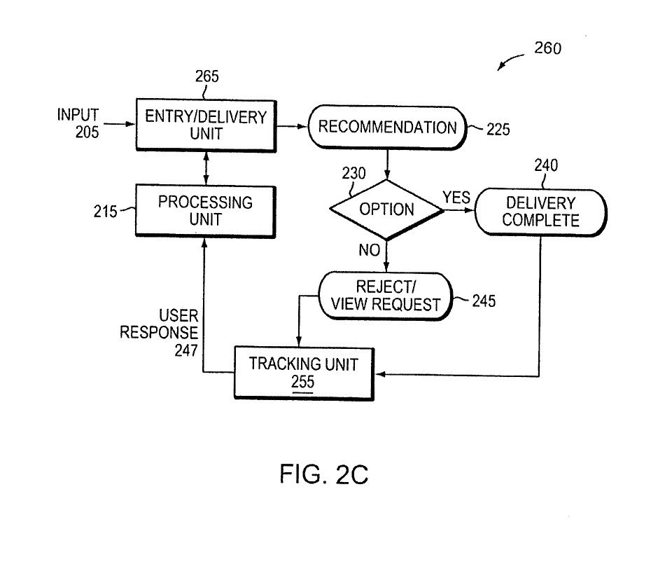

FIG. 2A is a block diagram of an example embodiment of a media based lifestyle choice recommendation apparatus 200 in accordance with the present invention. The data module 210 receives data input 205 that is either entered by or generated about a user or third party and maintains an aggregate of accumulated data including user-entered data and third party-entered/generated data. The user-entered data, third party-entered/generated data, or accumulated data 213 is directed by the data module 210 to the processing unit 215. The processing unit 215 synthesizes (e.g., normalize, index, cross-reference, classify, etc.) the data to match with a media based lifestyle choice recommendation and organizes the media based lifestyle choice recommendation(s). The processing unit 215 directs the synthesized data as matched with a media based lifestyle choice recommendation 217 to the delivery unit 220. The delivery unit 220 then delivers the resulting recommendation(s) (recommendation) 225 to the user based on the match. The user has the option 230 to accept the recommendation 225 and the delivery is complete 240 or to reject the recommendation/request a new recommendation 245. By rejecting or requesting a new recommendation 245, the user response 257 will be directed to the processing unit 215 for continued synthesis and matching. This may continue until delivery is complete 240.

FIG. 2B is a block diagram of another example embodiment of a media based lifestyle choice recommendation apparatus 250 in accordance with the present invention. The data module 210 and delivery unit 220 function in the same manner as described in FIG. 2A. The data is input 205 to the data module 210, which is an electronic device, such as a computer, handheld device, or mobile device. Note that third parties include mobile phone service providers, global computer network service providers and advertisers, other transaction parties and other parties sending/receiving electronic communications to/from the user or third party. Processing unit 215 uses software logic to synthesize data (both user-entered and third party-entered/generated) as discussed above. The delivery unit 220 is also an electronic device, such as a computer, handheld device, mobile device, or other display monitor.

Tracking unit 255 is coupled to delivery unit 220 and tracks the user response 247 to the recommendation (e.g., delivery complete 240 or reject/request new recommendation 245). The processing unit 215 is coupled to the tracking unit 255 and revises the accumulated data associated with the user, third party, or group of users based upon the user response 247. Revising the accumulated data includes applying user response 247 and evolving behaviors, both implicit and explicit, for a future recommendation. After the accumulated data is revised, it is stored in the database for use by the processing unit 215 in generating a match as described above.

FIG. 2C is a block diagram depicting another embodiment of the media based lifestyle choice recommendation apparatus 260 using an entry/delivery unit in accordance with the present invention. FIG. 2C functions in a manner similar to FIGS. 2A and 2B. The entry/delivery unit 265 receives input of user-entered data or third party-entered/generated data; maintains an aggregate of accumulated data, which includes user-entered data and third party-entered/generated data; and, delivers a recommendation to the user. Entry/delivery unit 265 is an electronic device, such as a computer, handheld device, mobile device, or other display monitor. Processing unit 215 synthesizes the accumulated data to match with a media based lifestyle choice recommendation and organizes the media based lifestyle choice recommendation for presentation. Processing unit 215 uses software logic to synthesize all data entry (both user-entered and third party-entered/generated) as described above. Tracking unit 255 tracks user response 247 to the recommendation as described in FIG. 2B and directs the user response 247 to the processing unit 215, which revises the accumulated data associated with the user, third party, or group of users. Revising the data entry includes applying user response 247 and evolving behaviors, both implicit and explicit, for a future recommendation. The user has the option 230 to accept the recommendation 245 or to reject the recommendation/request a new recommendation 245 as depicted in FIG. 2B.

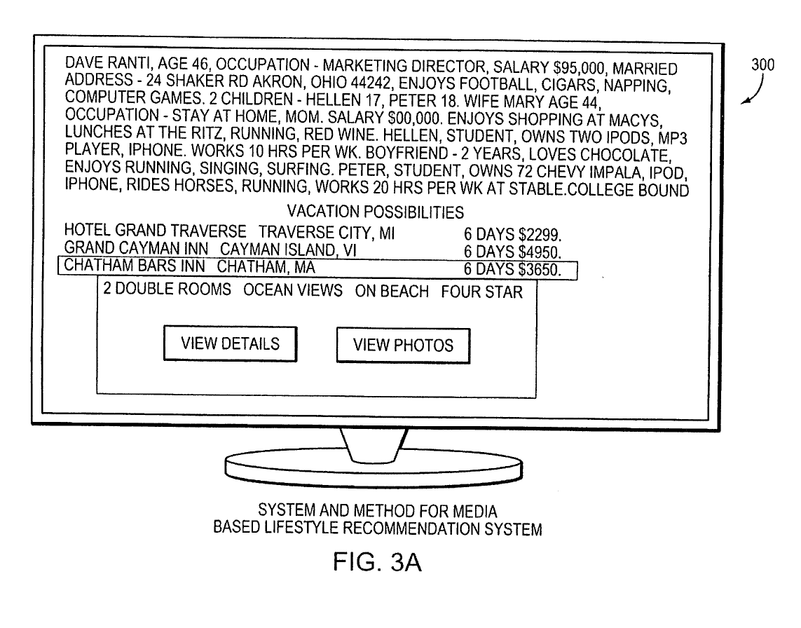

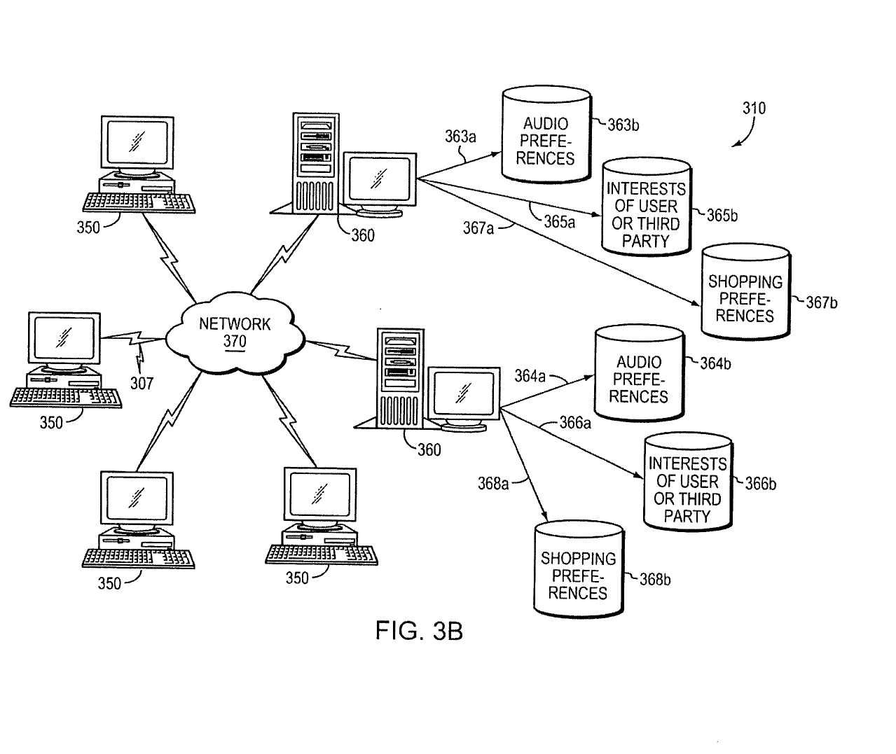

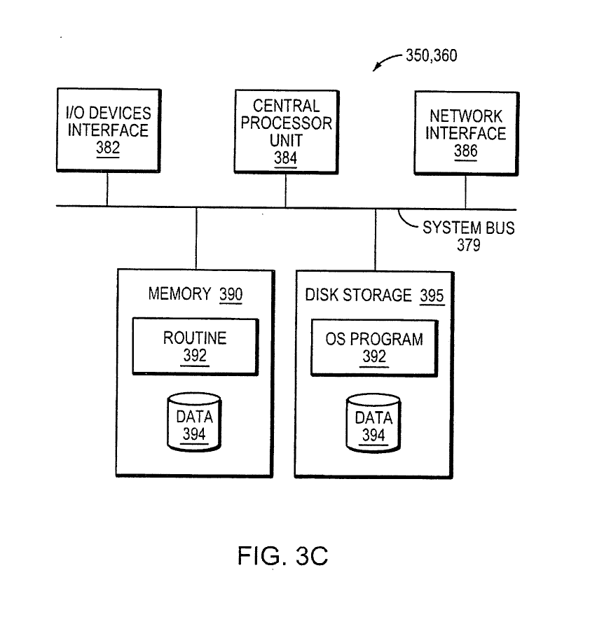

FIG. 3A is an exemplary screenshot 300 of vacation options (recommendations) that may be received by a user of the present invention. Any embodiment of the present invention may allow for the delivery of the recommendation electronically to the user. Delivery may occur online, in any media form online or offline, directly, or via a targeted demographic marketing campaign and so forth. In order for the present invention to electronically deliver the recommended vacation possibilities to the system user, the present invention may use such information about the user and associated third parties as the salary, family, interest, hobbies and any additional information necessary to develop a series of vacation possibilities. The user may receive a myriad of options based upon the matches made and recommendations presented by the system to the user, which include viewing additional details or viewing photos of certain options.

The system may also synthesize available information about the user or third party's economic condition and children's personal information, including likes and dislikes, grades, activities, goals, and match those parameters with public or private schools that correspond to the criteria of what the user or third party may afford, (including all aid, grant, and scholarship possibilities and/or likelihoods) and what the user or third party's child desires to receive from a schooling experience.

Additionally, the system may recommend real estate transactions based upon the user or third party family's needs and/or desires and economic situation. The system may locate real estate opportunities automatically and assemble possible financing packages based upon available cash, earnings, credit and overall borrower's profile. The system may even present real estate options in another part of the country or world based upon value and matching the overall needs and desires of user or third party's family. Based upon health conditions and personal appearance, the system may recommend certain medical checkups, diet and/or nutrition options, therapy, workout regime, and personal makeover. The system may perform a full analysis on what the user may pay for insurance as well as analyze and present the statistical relevance of the coverage and suggested options for a total insurance profile, including health, life, car, home and business insurance, based upon the available data. The same functions can be carried out for the following: financial planning, legal options without providing legal advice, travel, dating, transportation, media, restaurants, etc.

FIG. 3B illustrates a computer network or similar digital processing environment (510) in which the present invention may be implemented.

Client computer(s)/devices 350 and server computer(s) 360 provide processing, storage, and input/output devices executing application programs and the like. Client computer(s)/devices 350 can also be linked through communications network 370 to other computing devices, including other client devices/processes 350 and server computer(s) 360. Communications network 370 can be part of a remote access network, a global network (e.g., the Internet), a worldwide collection of computers, local area or wide area networks, and gateways that currently use respective protocols (TCP/IP, Bluetooth, etc.) to communicate with one another. Server computers 360 may be connected to storage devices that maintain a database of information relating to a user, third party associated with the user, or a selection or group of users. For example, a server computer 360 may be connected to audio preferences database (connection 363a to database 363b or connection 364a to database 364b), interest of the user or third party database (connection 365a to database 365b or connection 366a to database 366b), and shopping preferences database, (connection 367a to database 367b or connection 368a to database 368b). Other electronic device/computer network architectures are suitable.

FIG. 3C is a diagram of the internal structure of a computer (e.g., client processor/device 350 or server computers 360) in the computer system of FIG. 3B. Each computer 350, 360 contains system bus (bus) 379, where a bus is a set of hardware lines used for data transfer among the components of a computer or processing system. Bus 379 is essentially a shared conduit that connects different elements of a computer system (e.g., processor, disk storage, memory, input/output ports, network ports, etc.) that enables the transfer of information between the elements. Attached to bus 379 is I/O device interface 382 for connecting various input and output devices (e.g., keyboard, mouse, displays, printers, speakers, etc.) to the computer 350, 360. Network interface 386 allows the computer to connect to various other devices attached to a network (e.g., network 370 of FIG. 3B). Memory 390 provides volatile storage for computer software instructions 392 and data 394 used to implement an embodiment of the present invention. Disk storage 395 provides non-volatile storage for computer software instructions 392 and data 394 used to implement an embodiment of the present invention. Central processor unit 384 is also attached to system bus 379 and provides for the execution of computer instructions.

In one embodiment, the processor routines 392 and data 394 are a computer program product (generally referenced 392), including a computer readable medium (e.g., a removable storage medium such as one or more DVD-ROM's, CD-ROM's, diskettes, tapes, etc.) that provides at least a portion of the software instructions for the present invention system. Computer program product 392 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 307 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 392.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 392 is a propagation medium that the computer system 350 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to preferred embodiments thereof, it will be understood by those skilled in the art that various changes in form and details may be made therein without departing from the scope of the invention encompassed by the appended claims.

For example, the present invention may be implemented in a variety of computer architectures. The computer network of FIGS. 3B and 3C are for purposes of illustration and not limitation of the present invention. Additionally, the steps of the systems and methods illustrated herein may occur in any order either as requested by a user or automatically (e.g., in response to entry of data).

Further, the present invention generated recommendations are based on media collection and other associated information related to the user found in databases, screen scrapes or local searches of the user's computer. This information is made available by the user or formulated by the system using gathered and sorted data. One embodiment obtains data by ID3 tag conversion, fuzzy string searching, built in support to third party systems and media players with work-a-rounds or API support. Other embodiments utilize automated screen scrapes employing additional techniques, including perl scripts and software for the visually impaired. Another embodiment utilizes prior purchase information or an IP address “sniffer.” Recommendations may be presented spontaneously or upon user request, as pure data options or with a paid for sponsor integration ad model.

What is claimed is;:

1. A computer system employing multiple data transfers to generate a recommendation for a user comprising:
a data module configured to receive data from the user and to maintain an aggregate of accumulated data, the accumulated data including user-entered data, third party-entered data, and third party-generated data;
a processing unit coupled to the data module, including a database of entered data, and configured to synthesize the accumulated data entry to match with at least one media based lifestyle choice recommendation and to organize the at least one media based lifestyle choice recommendation; and
a delivery unit coupled to the processing unit and configured to deliver the at least one media based lifestyle choice recommendation to the user based on the match.

2. The system as claimed in claim 1, wherein lifestyle choice includes a user's present and future standard of living based upon day-to-day goods or services usage, needs, goals, desires, options, preferences, necessities, activities, economic standing, and mental or physical condition.

3. The system as claimed in claim 1, wherein the at least one of the data module and the delivery unit is any of a computer, a handheld device, or a mobile device.

4. The system as claimed in claim 1, wherein the accumulated data includes information about the user, a third party associated with the user, or a group of users; and
the information about the third party is optionally ranked for relevancy based upon the relationship of the user to the third party or group of users.

5. The system as claimed in claim 1, wherein the data entry module and the delivery unit are contained within an entry/delivery unit.

6. The system as claimed in claim 1, wherein the delivery unit is configured to allow the user to either accept, reject or request delivery of another media based lifestyle choice recommendation.

7. The system as claimed in claim 1, wherein delivery of the recommendation occurs electronically.

8. The system as claimed in claim 7, wherein delivery occurs online, in any media form online or offline, directly, or via a targeted demographic marketing campaign.

9. The system as claimed in claim 1, further including a tracking unit coupled to the delivery unit and configured to track a user response to the recommendation, wherein the tracking unit tracks the user response to the recommendation delivered based on data entered into the database whether used or unused by the processing unit in generating the recommendation.

10. The system as claimed in claim 1, wherein the processing unit is configured to revise the accumulated data entry associated with the user, third party, or group of users; and
wherein revising the accumulated data entry includes applying user response and evolving behaviors, both implicit and explicit, for a future recommendation.

11. A computer implemented method employing multiple data transfers to generate a recommendation for a user comprising the steps of:
receiving data from a user;
maintaining an aggregate of accumulated data, the accumulated data including user-entered data, third party-entered data, and third party-generated data;
synthesizing the accumulated data to match with at least one lifestyle choice recommendation; and
presenting to the user at least one lifestyle choice recommendation.

12. The method as claimed in claim 11, wherein lifestyle choice includes a user's present and future standard of living based upon day-to-day goods or services usage, needs, goals, desires, options, preferences, necessities, activities, economic standing, and mental or physical condition.

13. The method as claimed in claim 11, wherein any one or combination of the steps of receiving and presenting includes providing data through any of a computer, a handheld device, or a mobile device.

14. The method as claimed in claim 11, wherein the accumulated data includes information about the user, a third party associated with the user, or a group of users; and
the information about the third party is optionally ranked for relevancy based upon the relationship of the user to the third party or group of users.

15. The method as claimed in claim 11, wherein the step of receiving data and the step of presenting the recommendation to the user are accomplished by an entry/delivery unit.

16. The method as claimed in claim 11, further comprising allowing the user to either accept, reject or request delivery of another at least one media based lifestyle choice recommendation.

17. The method as claimed in claim 11, wherein presenting the recommendation occurs electronically.

18. The method as claimed in claim 17, wherein presenting the recommendation occurs online, in any media form online or offline, directly, or via a targeted demographic marketing campaign.

19. The method as claimed in claim 11, further comprising tracking user response to the recommendation, wherein tracking the user response includes utilizing data entry, both used and unused, in the match with the at least one lifestyle choice recommendation.

20. The method as claimed in claim 11, further comprising revising the accumulated data entry associated with the user, third party, or group of users; and
wherein revising the data entry includes applying user response and evolving behaviors, both implicit and explicit, for a future recommendation.

21. A computer apparatus employing multiple data transfers to generate a recommendation to a user comprising:
a handler receiving data from a user and maintaining an aggregate of accumulated data, the accumulated data including user-entered data, third party-entered data, and third party-generated data; and
a processing engine, coupled to the handler, synthesizing data to index the received and maintained data and matching the synthesized data to at least one media based lifestyle choice recommendation, said matching being based on information about the user, a third party, or a group of users and using an optional ranking of relevancy of information that correlates to relationship between the user and the third party or selection or group of users.

22. The computer apparatus as claimed in claim 21, wherein the processing engine further enables the user to accept, reject or request delivery of another media based lifestyle choice recommendation; and
tracks a user response to the recommendation and revises the accumulated data accordingly.

23. The computer apparatus as claimed in claim 21, wherein lifestyle choice includes a user's present and future standard of living based upon day-to-day goods or services usage, needs, goals, desires, options, preferences, necessities, activities, economic standing, and mental or physical condition.

24. A computer system employing multiple data transfers to generate a lifestyle choice recommendation for a user, the system comprising:
means for receiving data from a user and maintaining an aggregate of accumulated data, the accumulated data including user-entered data, third party-entered data, and third party-generated data;
means for processing data entry in a database by synthesizing the accumulated data and matching the synthesized data to at least one lifestyle choice recommendation; and
means for presenting the at least one lifestyle choice recommendation to the user.

25. The system as claimed in claim 24, wherein lifestyle choice includes a user's present and future standard of living based upon day-to-day goods or services usage, needs, goals, desires, options, preferences, necessities, activities, economic standing, and mental or physical condition.
